(19) United States
(12) Patent Application Publication
(10) Pub. No.: US 2020/0242495 A1
(43) Pub. Date: Jul. 30, 2020

(54) SYSTEM AND METHODS FOR CORRECTING BUILD PARAMETERS IN AN ADDITIVE MANUFACTURING PROCESS BASED ON A THERMAL MODEL AND SENSOR DATA

(71) Applicant: General Electric Company, Schenectady, NY (US)

(72) Inventors: Subhrajit ROYCHOWDHURY, Schenectady, NY (US); Alexander CHEN, Niskayuna, NY (US); Xiaohu PING, Niskayuna, NY (US); Justin GAMBONE, JR., Niskayuna, NY (US); Thomas CITRINITI, Niskayuna, NY (US); Brian BARR, Schenectady, NY (US)

(21) Appl. No.: 16/257,348

(22) Filed: Jan. 25, 2019

(51) Int. Cl. G06N 7/00; G06N 20/00; G06F 17/50; B22F 3/105

(52) U.S. Cl. CPC G06N 7/00; G06N 20/00; B33Y 50/02; B22F 3/1055; G06F 17/50

(57) ABSTRACT

Providing updated build parameters to an additive manufacturing machine to improve quality of a part manufactured by the machine. Sensor data is received from the additive manufacturing machine during manufacture of the part using a first set of build parameters. The first set of build parameters is received. An evaluation parameter is determined based on the first set of build parameters and the received sensor data. Thermal data is generated based on a thermal model of the part derived from the first set of build parameters. A first algorithm is applied to the received sensor data, the determined evaluation parameter, and the generated thermal data to produce a second set of build parameters, the first algorithm being trained to improve the evaluation parameter. The second set of build parameters is output to the additive manufacturing machine to produce a second part.

### FIELD OF THE INVENTION

The disclosed embodiments are directed to correcting build parameters in an additive manufacturing process based on a thermal model and sensor data.

### BACKGROUND

The term “additive manufacturing” refers to processes used to synthesize three-dimensional objects in which successive layers of material are formed by an additive manufacturing machine (AMM) under computer control to create an object using digital model data from a 3D model. One example of powder-bed fusion based additive manufacturing is direct metal laser sintering (DMLS), which uses a laser fired into a bed of powdered metal, with the laser being aimed automatically at points in space defined by a 3D model, thereby melting the material together to create a solid structure. The term “direct metal laser melting” (DMLM) may more accurately reflect the nature of this process since it typically achieves a fully developed, homogenous melt pool and fully dense bulk upon solidification. The nature of the rapid, localized heating and cooling of the melted material enables near-forged material properties, after any necessary heat treatment is applied.

The DMLM process uses a 3D computer-aided design (CAD) model of the object to be manufactured, whereby a CAD model data file is created and sent to the fabrication facility. A technician may work with the 3D model to properly orient the geometry for part building and may add supporting structures to the design, as necessary. Once this “build file” has been completed, it is “sliced” into layers of the proper thickness for the particular DMLM fabrication machine and downloaded to the machine to allow the build to begin. The DMLM machine uses, e.g., a 400 W Yb-fiber optic laser. Inside the build chamber area, there is a powder dispensing platform and a build platform along with a recoater blade used to move new powder over the build platform. The metal powder is fused into a solid part by melting it locally using the focused laser beam. In this manner, parts are built up additively layer by layer—typically using layers 20 to 100 micrometers thick. This process allows for highly complex geometries to be created directly from the 3D CAD data, automatically and without any tooling. DMLM produces parts with high accuracy and detail resolution, good surface quality, and excellent mechanical properties.

Anomalies, such as subsurface porosity, cracks, lack-of-fusion, etc., can occur in DMLM processes due to various machine, programming, environment, and process parameters, and due to the chemistry of the material used. For example, deficiencies in machine calibration of mirror positions and laser focus can result in bulk-fill laser passes not intersecting edge-outline passes. Such deficiencies can result in unfused powder near the surface of the component, which may break through the surface to cause anomalies which cannot be healed by post-processing heat treatment steps including hot isostatic pressing (HIP). Laser and optics degradation, filtration, and other typical laser welding effects can also significantly impact process quality, particularly when operating for dozens or hundreds of hours per build.

In conventional additive manufacturing practice, a part build plan (PBP) is generated for a particular part design and executed by the additive manufacturing machine (AMM). Based on the PBP, the AMM controls multiple build parameters that are applied during the build, including the travel path of the material addition zone and parameters governing the application and processing of the material added to the part in the zone. In general, there is a complex relationship between these parameters and the quality of the built part.

The design of the PBP is an iterative process, which includes building a part based on a trial PBP, followed by assessment of the resulting trial part quality, and then modification of the trial PBP to adjust the expected part quality. This iteration of trial PBPs to meet overall manufacturing requirements, such as part quality and production rate, may require multiple iterations to attain the desired manufacturing requirements. Conventionally, assessment of the trial part quality is done by experimental testing the part using either destructive or non-destructive techniques. In particular, DMLM parts may be sectioned, optical micrographs produced from the processed section, and the micrographs processed to quantify anomalies. The assessment of trial part quality is based on such tests. Such testing is laborious, expensive, and time-consuming, and significantly increases the time and cost of developing an acceptable PBP to release to final production.

In conventional approaches, parts are built using a fixed parameter set and then various physical measurements are made, such as cut ups/microscopic analysis, coherence tomography (CT) scans, and other inspection techniques to evaluate the quality of the different regions of the part. Subsequent builds are then performed in which the geometry may be segmented and assigned different parameter sets. The built parts are physically tested and further iterations are performed until the part quality converges to an acceptable range. Each such iteration may take, e.g., 3-4 weeks, because the part may need to be sent out to a specialized facility for performing the characterization, i.e., physical measurements, and then a design expert must interpret the characterization results and make decisions regarding segmentation and parameter changes. Such approaches may require 10 to 12 iterations, which means that it can take a year, or more, to produce an acceptable part. Another disadvantage of the manual segmentation/parameter revision approach is that the boundary of the power level segments tend to be likely failure points.

### SUMMARY

Disclosed embodiments provide a method to correct for predictable disturbances in a DMLM process using a combination of model and sensor data. Based on the time-scale of disturbance prediction, this technology can be used to improve part quality from build to build (e.g., for geometric disturbances) or even layer-to-layer (e.g., for smoke occlusions). The goal is to reduce cycle time for part parameter optimization, which is conventionally done by trial and error method and therefore may take weeks to converge to an acceptable parameter set. Also, the conventional approach is more art than science as the final outcome depends on the expertise of the person.

In disclosed embodiments, an initial guess for the scan parameters is estimated based on a model which can be executed quickly. The result of an iteration is recorded in the sensors and compared to a previously-generated reference, e.g., the result of a previous iteration or the output of a model. The estimation error is then fed back to improve the model via a tracking filter and the updated model is used to generate a new set of scan parameters. The scan parameters can then be further tuned using the tracking error as desired. Because of an algorithmic approach, the process is expected to converge to the optimal parameter set after just a few iterations within a single build. Furthermore, in conventional approaches, the iterations and adjustments are manual, so the outcome is dependent on the expertise of the engineer. An algorithmic approach provides better results without direct human intervention. In some conventional approaches, the iteration time for each cycle is a few weeks as the results of the iterations are evaluated by post-build cut-ups and material characterization. By contrast, using the algorithms described herein, results can be evaluated from the sensor data immediately after the build. Because the parameters are adjusted algorithmically, rather than through trial and error, fewer iterations are needed to converge. Conventional manual parameter optimizations take a material debit because they cannot segment a part with fine enough resolution to have different scan parameters along a strike.

Lower new product introduction (NPI) cycle time results in saved cost on complex parts and also greater throughput (i.e., more parts optimized during same time). The techniques described herein also have the potential to expand the design space by enabling geometries not possible otherwise. Combining sensor data with model data and updating the model using a tracking filter achieves higher fidelity results relative to conventional approaches.

Disclosed embodiments provide for predicting part quality without a physical testing step in every trial build iteration. A part quality model is developed based on sensor measurements made during the part build and other information known at the time of the build. Part quality-based decisions, such as modifications to the PBP, or part accept/reject, are based on the quality model results. Analyzing data generated during the build, and known at the time of analysis, instead of performing post-build testing reduces cost and elapsed time for PBP development, as well as cost and time for production part quality assessment. The disclosed methods may be substituted fully or partly for physical testing or may be substituted for some parts of the overall testing process (e.g., for long build times and expensive parts). The methods may be applied for selected iterations, with physical testing being utilized in a selection of iterations. The methods may be used to screen built parts and to reduce the quantity of parts undergoing physical testing. In disclosed embodiments, the output of the quality score generator may be attached to an entire part, sections of a part, an entire build, or sections of a build. The output of the quality score generator may be attached to portions of a part based on complexity or geometry, e.g., attached for contours, thin walls and overhangs, but not bulk regions. The output of the quality score generator may be binary, e.g., pass/fail, or may have multiple levels, e.g., high, medium, and low, in which case parts with a high quality score could be deemed premium parts, parts with a medium quality score could be deemed acceptable parts (i.e., parts for use in less critical applications), and parts with a low quality could be rejected. The output of the quality score generator may be a set of values indicative of particular types of post-processing required for the part, such as, for example, post-process A, post-process B, and reject. For example, some parts may need light hot isostatic pressing (HIP) processing, others may need intense HIP, others may have useful sections cut out, and others may be rejected.

In disclosed embodiments, the photodiode response to anomalies and microstructure variations in as-built condition, resulting from process variables may be considered, including correlation between quality score and microstructure of the post-processed parts, e.g., parts subjected to heat treatment and/or HIP. Materials microstructure and chemistry, of an additively built part or a representative area/section of a part, may be measured/mapped by direct (e.g., optical, SEM imaging) or indirect methods (e.g., diffraction, spectroscopy), where output could be a single value or set of single values for each measurement type (e.g., mean, median, standard deviation, etc.) or full-field spatially distributed map of the measured area. Methods for mapping/measuring microstructure and elemental chemistry distribution of as-built and post-processed additively-built parts may include, for example, optical imaging, scanning electron imaging, back-scattered electron imaging, electron-back scattered diffraction, energy or wave-length dispersive spectroscopy, atomic force microscopy, x-ray diffraction, transmission electron microscopy (both imaging and diffraction), and so on.

In disclosed embodiments, quality scores may be determined for different anomalies, such as, for example, pore density, crack density, and lack-of-fusion defect density. A single overall score may be derived from a combination of multiple sub-scores, e.g., sum, weighted sum, maximum, average, weighted average. Response maps, formed from a plurality of surface images, may be generated in which quality score is mapped to input process parameters (e.g., laser power, scan speed, beam spot-size/focus offset, and hatch spacing). Response maps may be generated in which as-built anomalies (e.g., pores, cracks, lack-of-fusion defects) and microstructure measured parameters (e.g., grain size and gamma/gamma prime size distribution) are mapped as a function of input parameters (e.g., laser power, scan speed, beam spot size/focus offset, hatch spacing), derived values (e.g., linear heat input, energy density, and beam intensity), process variables (e.g., melt-pool width and depth), and a generated quality score.

In one aspect, the disclosed embodiments provide a method (and corresponding system and software) for providing updated build parameters to an additive manufacturing machine. The method includes receiving, via a communication interface of a device comprising a processor, sensor data from the additive manufacturing machine during manufacture of the part using a first set of build parameters. The method further includes receiving the first set of build parameters. The method further includes determining, using the processor of the device, an evaluation parameter based on the first set of build parameters and the received sensor data. The method further includes generating, using the processor of the device, thermal data based on a thermal model of the part derived from the first set of build parameters. The method further includes applying, using the processor of the device, a first algorithm to the received sensor data, the determined evaluation parameter, and the generated thermal data to produce a second set of build parameters, the first algorithm being trained to improve the evaluation parameter. The method further includes outputting the second set of build parameters to the additive manufacturing machine to produce a second part.

Embodiments may include one or more of the following features.

The evaluation parameter may include a quality score determined by applying a second algorithm to the first set of build parameters and the received sensor data. The second algorithm may be trained by receiving a reference derived from physical measurements performed on at least one reference part built using a reference set of build parameters. The generating of the thermal data may include computing a first set of thermal data values based on a nominal thermal model and the first set of build parameters. The generating of the thermal data may include determining an updated thermal model based on a comparison of the first set of computed thermal data values to the received sensor data; and computing a second set of thermal data values based on the updated thermal model. The nominal thermal model may be derived by: dividing a volume of the part into voxels; determining a relative amount of surrounding material within a defined radius of a center of each of the voxels; and computing thermal data values for each voxel based on the relative amount of surrounding material. The sensor data may be received from at least one of a laser power sensor, an actuator sensor, a melt pool sensor, and an environmental sensor.

### BRIEF DESCRIPTION OF THE DRAWINGS

FIG. 1 is a block diagram of a system for correcting build parameters for producing a part in an additive manufacturing process;

FIG. 2 is a diagram of a system for determining a quality score for the produced part using a quality score generator which receives sensor data from the additive manufacturing machine;

FIG. 3 is a diagram of the quality score generator;

FIG. 4 depicts a system for updating a thermal model of the part produced in the additive manufacturing process;

FIG. 5A depicts a portion of a part which is voxelized to produce a nominal thermal model;

FIG. 5B depicts, in a top view, determining a relative amount of surrounding material within a defined radius of a center of a particular voxel;

FIG. 5C depicts, in a side view, determining a relative amount of surrounding material within a defined radius of a center of a particular voxel; and

FIG. 6 is a block diagram of a system according to some embodiments.

### DETAILED DESCRIPTION

Performing an additive manufacturing build using a parameter set which is fixed for all positions in the geometry of the part may not produce satisfactory results. For example, suppose a design uses a fixed parameter set developed based on the properties of the material being used in the manufacture of a part. Such a parameter set may work well in bulk regions of the part (i.e., portions having a relatively uniform geometry). However, in a thin-walled portion of the part having much less heat conductivity than the bulk regions, the melt pool size will be larger, and the melt pool will be hotter, so there may be significantly different material properties in the thin wall region than in the bulk region, which may lead to unsatisfactory part quality when a fixed parameter set is used. As a further example, if a part has overhanging surfaces, e.g., an arch, then there is very little thermal conductivity. Consequently, the melt pool will be relatively much larger which results in the built part having a very poor surface finish. Thus, a build performed with a nominal parameter set can result in deficiencies in the material properties. A nominal parameter set can be adjusted in attempt to improve the properties of the surface of the material. For example, the laser power can be reduced throughout the build or in a segmented region. However, such an adjustment can introduce or increase porosity of the material.

In disclosed embodiments, iterative learning control (ILC) is used in the design phase to apply variable correction to the build parameters for predictable disturbances, e.g., to correct laser power level as a function of laser position. ILC is especially useful for part geometries in which thermal conductivity varies significantly in different portions of the geometry. With ILC, there is a finer control of build parameters, so fine-grained regions can be controlled separately. This configuration helps minimize the introduction of porosity because there is finer control of the laser power.

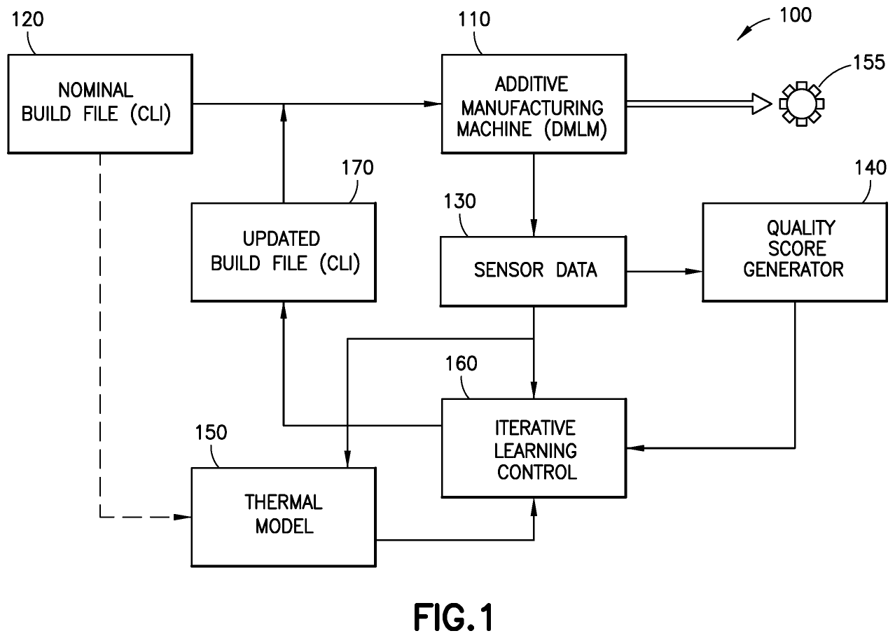

FIG. 1 is a block diagram of a system 100 for correcting build parameters for producing a part in an additive manufacturing process. The system uses a thermal model and an evaluation parameter (e.g., a quality score) derived from build parameters and sensor data. A set of nominal build parameters is input to an additive manufacturing machine (AMM) 110, such as, for example, a direct metal laser melting (DMLM) printer (i.e., machine). The nominal build file 120 may be in the form of a common layer interface (CLI) file, which may include a set of scan parameters, i.e., build parameters. As the DMLM printer 110 performs the build, based on the nominal build file 120, sensor data 130 is collected from various sensors associated with the printer. The sensor data 130 is input to a quality score generator 140, which calculates a score indicative of the quality of the built part without extensive physical testing of the part.

The nominal build file 120 is also input to a thermal model 150, which models the thermal response of the built part to the applied laser power. As described in further detail below, the thermal model 150 uses the nominal build file 120 and sensor data 130 received from the DMLM printer 110 to predict the heat density within the volume of the built part 155 which would result from applying a particular level heat input from the laser during a scan. The thermal model 150, in effect, creates a correlation between heat input parameters specified in the build file (e.g., laser power and scan speed) at each position in the scan path, with an expected sensor reading for that position, e.g., a photodiode reading, during the build.

The sensor data 130, the quality score calculated by the quality score generator 140, and the output of the thermal model are input to an iterative learning control (ILC) 160. As described in further detail below, the ILC 160 uses machine learning algorithms to produce an updated build file 170 based on these inputs. The ILC 160 thus creates a mapping between the scan parameters of a build file and the resulting quality score of a part produced using the build file, which allows a build file to be optimized using an iterative machine learning process. This process results in a built part having higher quality without performing multiple rounds of experimental testing, as in conventional approaches.

Iterative learning control 160 is a term which covers various learning and control algorithms which are configured to learn from previous builds and improve the quality of subsequent builds. Disclosed embodiments provide for application of the quality score, in control applications which require a reference to track, through use of iterative learning processes. The generation and use of a quality score, as discussed herein, allows for an array of physical characteristics to be modeled, such as, for example, porosity, surface finish, etc., which are conventionally determined using cut ups. In disclosed embodiments, sensor data and other input data can be examined to determine physical properties of a built part, e.g., porosity and surface finish, and these sensor spaces can be used in a model to achieve parts of desired quality.

In disclosed embodiments, given various inputs, e.g., sensor inputs and process parameters, a model can predict quality score which, in turn, can be used to determine whether the built part will be acceptable. If predicted part quality is not acceptable, then various actions can be taken to improve the manufacturing processes. In other words, given the model, given the response map with sensors, given the build data and the scan file (e.g., CLI build file), the quality score generator can be used to predict whether a build was acceptable or not. If the quality score indicates that the build will not be acceptable then the ILC tries to understand what is not acceptable (e.g., via machine learning algorithms) and make corrections to the scan file of the part being built to make future builds more acceptable.

In general, there may be a number of different disturbances acting on the fabrication process. If there were no disturbances, one could design an ideal scan parameter set, e.g., laser power, speed, etc., and one would expect that every time this parameter set (i.e., “recipe”) were executed, the result would be a part having the desired characteristics. However, this does not happen because there disturbances acting on the system throughout to dislodge the process from its nominal values. Some of these can be predictable disturbances, e.g., if one is trying to build the same geometry, then the thermal conductivity is a disturbance that would be same for every instance, i.e., every build. Similarly, if the same machine is being used and there is a problem in the optic train, then the problem is known and one can calibrate for that. On the other hand, there will be some disturbances which will be random and will therefore vary from build to build. Such disturbances cannot be compensated for in a predictable manner. Iterative learning control (ILC) is used to learn from historical builds and correct in subsequent builds, which may be considered to be a “feed forward” control process. This is only possible for predictable disturbances—the algorithm learns what can be predicted and compensates for that. For random disturbances, on the other hand, feedback control process may be used.

The ILC has a control algorithm which, in a first loop, receives a tracking error determined based on a set of reference (i.e., desired) quality scores compared to quality scores predicted based on sensor data measured during the build. Based on the tracking error, the algorithm updates the build file (i.e., scan file or parameter set) for use in the next build iteration. Alternatively, as noted above, a set of reference sensor data values may be used as the basis of comparison in the tracking error loop. In such a case, the measured sensor data is compared to the reference sensor data values in the tracking loop, as opposed to converting the measured sensor data to quality scores (using the reference surface) and comparing the quality scores to a desired quality score target.

In disclosed embodiments, the ILC receives, in a second loop, an estimation error which is a comparison of predicted sensor data values to measured sensor data. The sensor data is predicted using a thermal model, which begins as a nominal thermal model, but is then updated by the algorithm based on the estimation error. The thermal model receives the build parameters, e.g., scan file, and based on this input predicts a set of sensor data values. In the case of a perfect thermal model, the predicted sensor data values would correspond exactly to the measured sensor data. Because the nominal thermal model is not perfect, the actual sensor response is different from the predicted sensor response—this difference is the estimation error. The estimation error may be fed to a tracking filter, which compares the predicted sensor data values (i.e., predicted by the thermal model) and the measured sensor data and updates the thermal model in manner adapted to minimize the estimation error.

The two loops of the ILC described above, which may be referred to as the iterative learning control loop and the tracking filter loop, respectively, can run independently (e.g., one at a time) or may operate in combination. It is noted that the terminology used herein describes the tracking error as being fed to the ILC and the estimation error as being fed to the tracking filter.

In disclosed embodiments, the ILC loop and the tracking filter loop are used in combination to iteratively minimize both types of error, i.e., tracking error and estimation error. The minimization of tracking error means that the predicted quality scores of the built part should move from an unacceptable range to the acceptable/desired range. The minimization of the estimation error means that the thermal model is approaching a high level of accuracy. Consequently, the predicted sensor values will closely match measured sensor data, which will allow the ILC loop (which depends on the thermal model) to converge more quickly. As noted above, the tracking filter loop can be used in disclosed embodiments without the tracking filter loop, because the nominal thermal model may be sufficiently accurate in practice. As discussed above, in conventional approaches, applying power correction unsystematically to the whole part, or regions of the part, to optimize, e.g., surface finish, results in a debit to other material properties, such as porosity. Using ILC, on the other hand, allows build parameters, such as power, to converge in manner that can lead to improved material properties without a significant trade off with respect to any one material property.

As discussed above, if a part being built has difficult geometry, such as an overhang region, there will be a relatively large melt pool due to reduced thermal conductivity in the region in question, i.e., less heat is conducted away from the region by the bulk material of the part, resulting in reduced part quality. In such a case, a relatively large power reduction may be needed to compensate. In other words, the larger the melt pool, the larger the power “delta” that is needed. In some cases, laser velocity and focus may also have a delta applied to help compensate for the larger melt pool.

In disclosed embodiments, the corrected laser power level may be determined iteratively according to the following formula in which i is an integer representing the iteration number (the i^{th} iteration), k-ᵢ and k₂ are experimentally-determined gain coefficients for sensor error and thermal error, respectively:

Corrected_Powerᵢ=Powerᵢ+k₁*tracking_errorᵢ+k₂*estimation_errorᵢ

The tracking error (tracking_error) in the equation above is determined based on a set of reference (i.e., desired) quality scores compared to quality scores predicted based on sensor data measured during the build. Alternatively, as noted above, a set of reference sensor data values may be used as the basis of comparison in the tracking error loop. The tracking error approaches zero as the iterations converge.

The estimation error (estimation_error) in the equation above is determined based on a comparison of the predicted sensor data values (i.e., predicted by the thermal model) and the measured sensor data. The estimation error approaches zero as the iterations converge.

In disclosed embodiments, a sensor error map may be determined based on the difference between a reference intensity and the photodiode sensor intensity (i.e., the measured sensor data). If the photodiode sensor intensity is represented as “Intensityᵢ”. A conversion to power (e.g., in Watts) is given by taking the median power setting (i.e., the nominal laser power set in the build file) over all scan paths (i.e., hatches) divided by the median measured intensity over the hatches (i.e., the measured sensor data). Then the (pointwise) sensor error is:

sensor_errorᵢ=(Refᵢ-Intensityᵢ)*intensity_to_power_scaling

This computed sensor error would correspond to the tracking error in alternative embodiments in which a set of reference sensor data values is used as the basis of comparison in the tracking error loop (i.e., embodiments in which the measured sensor data is compared to reference sensor data values in the tracking loop, as opposed to converting the measured sensor data into quality scores using the reference surface and comparing the quality scores to a desired quality score target). The sensor error obtained in this manner is in terms of the photodiode intensity. Corrected power is then given by:

sensor_corrected_Powerᵢ=Powerᵢ+sensor_errorᵢ

The sensor corrected power determined in this manner may be applied to subsegments of the scan path as a uniform power setting in embodiments in which continuous small adjustments to the laser power are not possible or desired. As discussed above, the ILC loop is adapted to adjust corrected_Power; so that residual heat in the bulk material of the part is distributed more evenly throughout the build. In some cases, input power can be adjusted continuously at a very fine time scale. However, many small adjustments to the laser can be costly. Thus, in place of a point-wise corrected power, stipulating a piece-wise (i.e., subsegment) constant model is sometimes more practical. To this end, a sub-segmenting procedure is employed, in which subsegments of relative stability in the corrected power are determined. Then, the median of corrected power along the subsegment is set to be the corrected power in the segment.

In some cases, the sensor error, and therefore corrected power, tends to be large near the beginning of a segment. In such a case, a moving average of corrected power may be used for better stability of the algorithm. For example, for each hatch line, starting at (x₀, y₀), a new subsegment may be started at (x, y) when |y-y₀|>0.1y, as long as, for example, |x-x₀|>100 μm. Once the corrected power signal has stabilized, the x-threshold is increased, e.g., to 300 μm. An example of this sub-segmenting procedure is below. For each sensor reading, an associated thermal input qᵢₙ is determined for the region (e.g., voxel) in which it is located.

For thermal model-based correction, the thermal model may be introduced in the following equation for the intensity measured by a sensor, e.g., an avalanche photodiode (APD):

Intensity=C₁*Laser Power+C₂*VF+C₃.

This equation can be rewritten to solve for power, as follows:

thermal_powefᵢ=(Intensityᵢ−C₂*VFᵢ−C₃)/C₁

In these equations, C₁, C₂, and C₃ are experimentally-determined coefficients, and VF is the volume fraction determined for the particular voxel during calculation of the nominal (i.e., initial) thermal model (the variable thermal_power is used in lieu of Laser Power).

A thermal error map can be determined based on the difference between the thermal input qᵢₙ and the measured sensor intensity. The thermal error is then:

thermal_errorᵢ=Refᵢ*intensity_to_power_scaling−thermal_powerᵢ

where Refᵢ is the same reference intensity used in the calculations for the sensor error.

The corrected power for the thermal model can be calculated as

thermal_corrected_powerᵢ=Powerᵢ+thermal_errorᵢ

The sensor-based and thermal model-based power corrections can be combined to form a model for obtaining a total corrected power for the next build, using an equation similar to that presented herein for corrected power based on tracking error and estimation error:

corrected_power=Power+k₁*sensor_error+k₂*thermal_error

where k₁ and k₂ are gain parameters.

The corrected power is used in a new build file (e.g., CLI file) to build the next iteration. In disclosed embodiments, for subsequent builds (i.e., after the first power-corrected build), an extra step is used. Instead of applying the sub-segmentation discussed above to the already-sub-segmented previous build, the sub-segmentation procedure is applied to the original set of hatches (i.e., scan paths). Thus, the new sensor data is first registered with the previous build so that an associated input power can be obtained at each point. Then these segments are identified with the original set of hatch lines (obtained from the first uncorrected build). After this, the steps presented above can be applied to obtain a new power-corrected build.

In disclosed embodiments, a quality score is defined and used to point out what kind of defect has happened (or will happen) in a built part in a probabilistic sense. For example, for a particular process, a determined melt pool temperature and dimensions may be needed for acceptable part quality. Other techniques consider variables of interest, such as laser power and speed, and try to detect shifts in those variables. However, such techniques do not provide an indication of whether the determined deviation will lead to, e.g., lack of fusion, porosity, and cracks in the built parts and the likelihood of such defects. The quality score analysis, on the other hand, takes input data and, based on a mapping to the quality score, predicts defects in the built parts and their likelihood. Conventionally, such evaluative outputs are obtained by performing destructive analysis of parts, e.g., cut ups. Once a parameter set is obtained, a build is performed with the parameter set, the sample (i.e., part) is taken out of the machine, and a cut up of the part is performed. A defect score may be obtained from automated analysis under a microscope. When this process is done for a set of points, for a specific set of input parameters, a response surface results. Based on the scores determined from the analysis of the cut-up layers, there may be portions of each layer which are good, portions which are bad, and portions in a gray area in between. These points may be depicted visually as a response surface having, e.g., red, blue, and green regions. A response surface is a mathematical function derived via experiments where there is a set of input parameters, such as, laser power, focus, scanning speed, hatch spacing, and layer thickness. The output of the response surface (i.e., function) may be, for example, porosity score, cracking (i.e., defects) score, and lack of fusion score.

The response surface may be expressed as an N-dimensional vector function. For example, if a function has inputs X and Y and outputs A and B, then this function from {X, Y} to {A, B} would be referred to as a 2x2 vector function. In disclosed embodiments, the response surface is n x m vector function. The inputs can be build parameters, e.g., power, speed, focus, hatch spacing, layer thickness, as well as measured reference sensor data. The outputs of the reference surface are quality scores derived from physical assessment of the material properties of the reference parts, e.g., porosity, lack of fusion, micro-cracking, etc., mapped over the surface and/or volume of the parts.

A lookup table may be used to express the reference surface, in which case a set of inputs looked up in the table will provide a predicted set of outputs values, e.g., quality scores. A large amount of data may be needed to compute the reference surface, but techniques, such as extrapolation using machine learning techniques, can augment the measured data. In disclosed embodiments, a relatively simple reference surface may be used which maps porosity quality scores to laser power levels. Based on this simple reference surface, collected sensor data can be input to a reference surface lookup table, which will output quality scores indicating whether the quality of the built part is acceptable. If the quality scores determined in this manner are acceptable, then the design, i.e., the build file, may be frozen and declared ready for production. If the quality scores are not acceptable, then the parameters in the build file may be adjusted using iterative learning control (ILC), as discussed in further detail below. Alternatively, a set reference (i.e., target) sensor data values may be derived using the reference surface and used as the basis of comparison.

Disclosed embodiments provide for recording sufficient sensor data to extend the input space so that the sensor data, in conjunction with input parameter set, provides enough information to allow prediction of a defect score. Destructive testing is performed to generate an x-mat surface and these results are then generalized to apply to any built part. In other words, an experimentally-obtained x-mat surface is aligned with input parameters to get model of system.

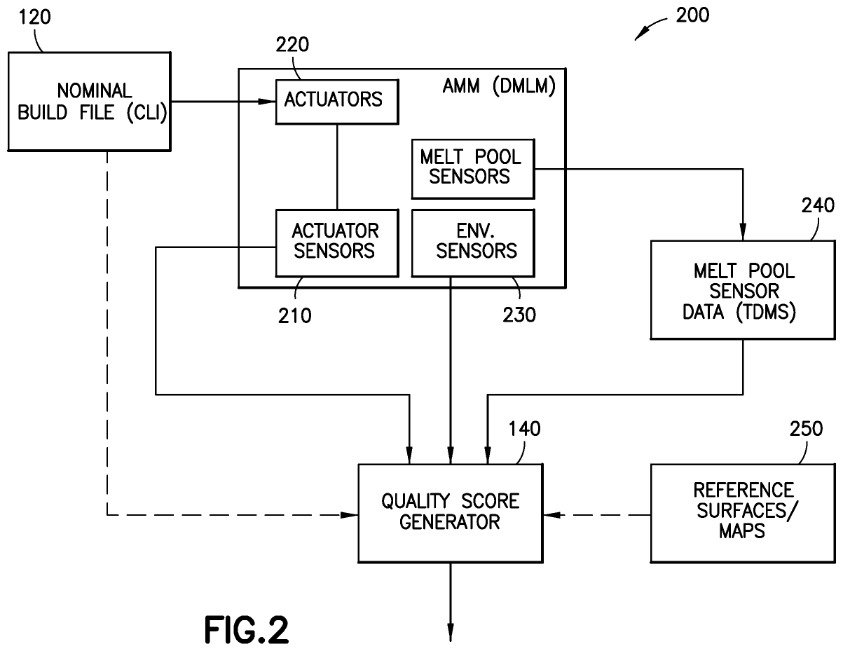

FIG. 2 is a diagram of a system 200 for determining a quality score for a produced part using a quality score generator 140 which receives sensor data from an additive manufacturing machine 110. The sensor data may include data from actuator sensors 210 associated with actuators 220 in the AMM 110, such as galvanometer position sensors. The sensor data may also include data from environmental sensors 230, such as, for example, atmospheric pressure, oxygen level, airflow, smoke, etc. The sensor data may also include data from sensors 240 monitoring characteristics of the melt pool, such as, for example, photodiode, pyrometer, acoustic emission, etc. Also, as explained in further detail below, the quality score generator 140 receives training data, e.g., response surfaces/maps 250 derived from experimental testing of built parts.

As the additive manufacturing machine 110 (e.g., a DMLM machine) performs a build, the machine produces output data from melt pool sensors 240, e.g., in the form of data files in technical data management streaming (TDMS) format. Data is also produced by other sensors of the machine, such as, for example, actuator sensors 210 measuring galvanometer position, which positions the laser spot, and various environmental sensors. Other sources of data include commands to additive machines, materials property data, and response surfaces/maps 250. The built-part properties are determined based on these various process parameters. As discussed above, the data from the DMLM machines can be used as inputs to a quality score generator which outputs a quality score. Such a quality score could be, in a simple case, a “go/no-go” score. In disclosed embodiments, a numeric score is used to indicate the quality of a built part. In disclosed embodiments, the quality score is used after the part is built (or during the build) to assess whether the part is of acceptable quality. This is done in lieu of, or in conjunction with, other more time-consuming evaluation processes, such as cut up and analysis of the parts.

Conventionally, such evaluative outputs are obtained by performing destructive analysis of parts, e.g., When this process is done for a specific set of input parameters, a response map can be generated. Based on the scores determined from the analysis of the cut-up layers, there may be combinations of input parameters which yield good results, combinations which yield bad results, and gray areas in between. These combinations of input parameters may be depicted visually in the response map as the axes of a 2D or 3D plot, while the output (e.g., density of anomalies or quality score) may be represented by color-coded, e.g., red, blue, and green regions.

In disclosed embodiments, the response map (e.g., a “response surface”) may be, for example, a direct illustration of experimental data on a 2D, 3D, or 3D with color coding plot, or a mathematical function derived via experiments where there are inputs given by: (i) a set of parameters, such as, laser power, focus offset or beam spot-size, scanning speed, hatch spacing, and layer thickness, and/or (ii) measured or derived process variables, such as melt-pool depth, melt-pool width, melt-pool temperature, and/or thermal gradient. The output obtained from the response map may be, for example, a color-coded plot of density of anomalies or defects, such as, area or volume percentage of pores, cracks, and lack-of-fusion defects. It should be noted that the term “response surface” is being used to describe a mathematical relationship between various process inputs, such as those mentioned above, and the density of anomalies, as opposed to something relating to the physical surface of a part being built.

Disclosed embodiments provide for recording sufficient sensor data to extend the input space so that the sensor data, in conjunction with input parameter set, e.g., a build file, provides enough information to allow prediction of a defect score (e.g., quality score) without performing cut ups (i.e., dissecting) and/or doing other direct part testing, such as optical coherence tomography (OCT) imaging. In disclosed embodiments, experiments, e.g., physical testing, is performed to generate a response surface and these results are then generalized, e.g., by creating a model, to apply to any built part.

In disclosed embodiments, an association is created between all input variables and some form of quantified notion of quality score, which may be discrete or continuous (e.g., low/med/high or a real number). An initial version of model (e.g., a regression model) may be used to build a direct association from input variables to the output quality score. Such a model may use an equation expressed in terms of the input variables with coefficients, i.e., a regression model. The relationship between the input variables and the output may be highly non-linear and complex, as there are potentially a large number of inputs (e.g., the intensity of each pixel of a 256×256 pixel image) and potentially only one output, i.e., the quality score. Transformations of the input variables may be created, i.e., explicitly transforming the input variables into “feature space,” or neural networks, decision trees, etc., may be used, i.e., machine learning. This provides a space where the problem of mapping is made easier. In other words, one may start with direct variables and construct latent variable spaces to simplify the problem. Machine learning, in particular, can be used to take high-dimension, multiple-variable space and map it to an output where the underlying relationship is known to be complex, non-linear, and non-trivial.

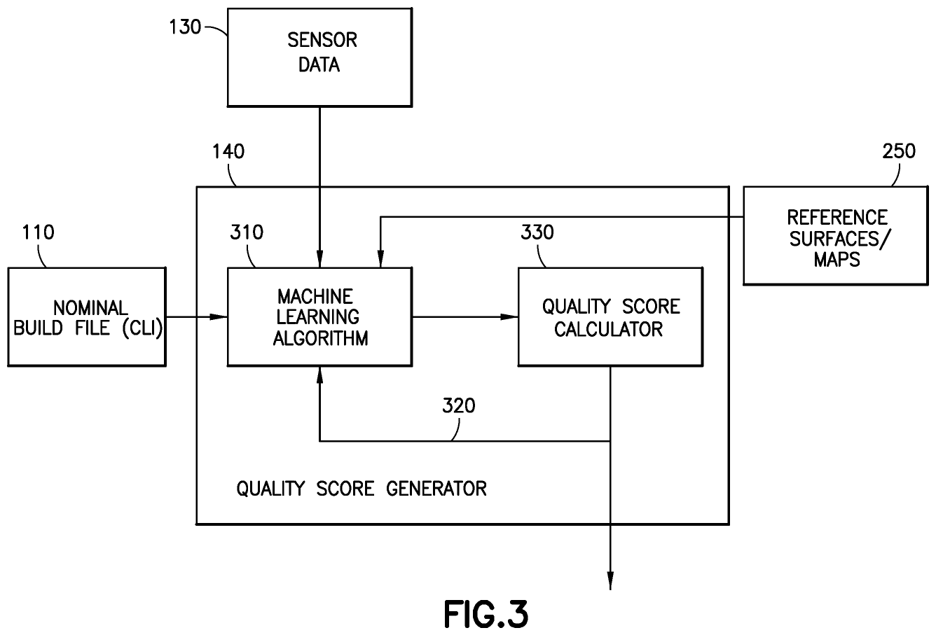

FIG. 3 is a diagram of the quality score generator 140. As explained above, the quality score generator 140 receives sensor data 130 from the AMM, the nominal build file 120 for the part being produced, and reference data 250 derived from testing of built parts. The sensor data 130 and nominal build file 120 are input to a machine learning algorithm 310 which is trained to produce a quality score for a built part. The machine learning algorithm 310 is trained using a response surfaces/maps 250 which, as discussed above, is derived from physical testing of the part. Such testing may involve slicing a built part and analyzing each slice, e.g., using optical coherence tomography (OCT), to determine the presence and densities of the various types of anomalies. A quality score calculation 330 may be performed, such as, for example, the combining of quality scores for different types of anomalies, and the result is output by the quality score generator 140. Alternatively, the machine learning algorithm 310 may determine a quality score which is directly output by the quality score generator 140.

In disclosed embodiments, three types of anomalies may be considered: pores, cracks, and lack-of-fusion defects. An indication of the overall area or volume percentage and/or density of such anomalies, e.g., a quality score, can be predicted for each of such characteristics or these quality scores could be combined to obtain a sum, maximum, weighted average, etc., depending on relative importance of these characteristics vis-a-vis desired physical and mechanical performance. For example, in some situations cracks might be the most important characteristic, whereas in other situations pore density and lack-of-fusion anomalies might be more significant.

To train the machine learning algorithm 310, cut ups of built parts may be performed to produce response surfaces/maps 250. In disclosed embodiments, images of the cut ups can be divided into smaller sub-regions, e.g., regions of 3×3 pixel space (k×k, in general, where k can be treated as a parameter), thereby turning the image into vectors, i.e., flattening the image. Numerical matrices may be generated which have a number of inputs, e.g., nine variables for each 3×3 pixel space, with one output variable. It is determined whether the examination after the cut up has revealed any anomalies in that 3×3 pixel space, which means that one is locally looking at image and asking whether there is a lack-of-fusion or any porosity issues or other anomalies. Then a label is assigned to the 3×3 pixel being examined. In other words, on a binary scale, does this 3×3 pixel region have an anomaly or not. This amounts to a binary classification problem, which is the typical data format by which machine learning models consume input, although the multi-class versions of this problem, whereby the different classes would be the different defect-types, can also be solved using machine learning methods for multi-class classification problems. In either case, a multi-variate latent variable model, i.e., machine learning model, can perform mapping between a nine-element vector (n-element vector, in general) to a single value. With such a model, one can create any 3×3 (k×k, in general) pixel combination of intensities and feed it to the model and it will indicate the likelihood of a defect (or defect type) being present in the corresponding sub-region of the built part.

In alternative embodiments, instead of flattening measured part data into a matrix, the image can be consumed as a whole by the machine learning algorithm 310, which may be, e.g., a deep learning model, such as fully convolutional networks or “U-Nets.” Such a model could be used to construct a predicted micrograph image directly from the sensor data. In alternative embodiments, rather than using a two-dimensional image, a set of three-dimensional slices may be used. In other words, instead of a 3×3 set of pixels, one could examine a 3×3×3 pixel cube. Furthermore, although metallic cross-sections have been described, it is also possible to produce three-dimensional reconstructed volume from 2-D computed tomography (CT) slices and to correlate sensor data in 3D space and 3D CT images.

In disclosed embodiments, a statistical quality transfer function is developed to predict the density of specific anomalies in the built parts. Various types of anomalies may be considered, such as, for example, pores, lack-of-fusion defects, and cracks. The significant parameters for a part being built may include the mean value of photodiode signal and particular process parameters, e.g., the laser power setting and power divided by laser scan speed. A linear or nonlinear model may be used to provide a transfer function which, in disclosed embodiments, has a relatively high r-squared factor, e.g., of higher than about 0.8.

In disclosed embodiments, there may be at least two types of response surfaces/maps 250. A first type may be produced based on controlled experiments which seek to describe the properties of the material of the part based on input parameters, e.g., laser power, focus, and speed. In such a case, a part may be produced and subjected to analysis, such as cut ups and imaging. Algorithms, e.g., machine learning, may be used in connection with a relatively small number of iterations. The results of such experiments provide an indication of regions in a laser parameter space which will give parts a sufficiently low density of anomalies. This, in turn, may be used to set initial settings of the additive manufacturing machine (AMM).

A second type of response surfaces/maps 250 may include laser parameters such as those mentioned above in combination with sensor output data. For example, while the manufacturing process is being run, sensors such as photo diodes and cameras may be used to measure characteristics of the melt pool, e.g., size and temperature. The sensor data may, for example, show that laser parameters do not necessarily translate into stable melt pool characteristics. For example, the measured photodiode signal may not be constant, i.e., it may have variation and may not be a clean signal with respect to spatial locations of the part. Therefore, the characteristics of the sensor outputs, e.g., the photodiode output signal, may provide another way to predict the quality of a part. Thus, the information on material properties provided by the first type of response surface, which can be used to set the laser parameters, can be supplemented by sensor readings to provide a more accurate model of part quality.

In disclosed embodiments, the quality score generator 140 receives sensor data 130, and applies a multi-dimensional mathematical formula or algorithm, e.g., a machine learning algorithm 310, to produce a quality score, which may be a number or a set of numbers. The algorithm 310 may be trained by making several builds of part and performing physical testing, e.g., cut ups and/or volumetric CT, etc., to measure anomalies/defects. This may include building relatively simple reference parts and using varying sets of laser parameters to build the parts. Such experiments may be an adjunct to the experiments discussed above, which are used to produce response surfaces. The quality score generator may be adapted to use a formula that takes various types of anomalies, e.g., porosity, lack of fusion, cracking, and combines the corresponding individual quality scores to produce an overall quality score (e.g., by using a weighted average). The combined quality score could be adapted to give greater weight to particular types of anomalies. Thus, the quality score algorithm may be trained through experimentation, e.g., by a number of iterations of producing and physically analyzing parts.

Once the algorithm 310 is sufficient trained, one can input measured sensor data 130 and a nominal build file 110 for a non-experimentation case and the algorithm 310 can output a response surface (e.g., a plot representing a multi-dimensional relationship between inputs, such as laser parameters and sensor data, and outputs, such as density of anomalies) just as if physical testing and analysis had been performed. The generated response surface can then be quantified in terms of a quality score. For example, the quality score may be obtained via a further calculation, such as an averaging of densities of anomalies. Alternatively, the algorithm 310 can directly output one or more quality scores, which can be used separately or mathematically combined. The determined quality scores may be fed back 320 to the algorithm 310.

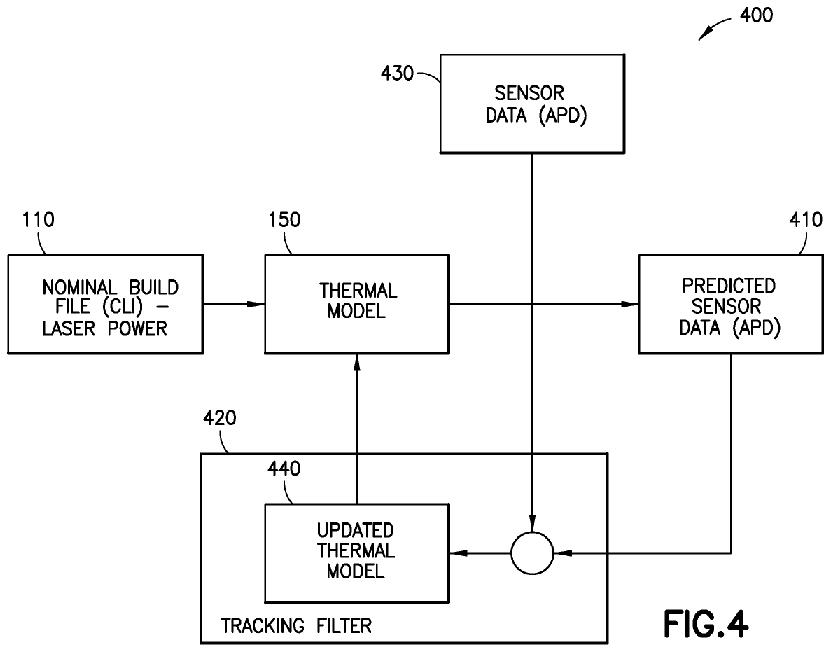

FIG. 4 depicts a system 400 for updating a thermal model 150 of the part 155 produced in the additive manufacturing process. As noted above, the thermal model 150 uses the nominal build file 120 and sensor data 130 received from the AMM 110, e.g., the DMLM printer, to predict the heat input in the volume (i.e., energy density) of the built part 155 which would result from applying a particular level of laser power during a scan. The thermal model 150 converts the predicted energy density into corresponding predicted sensor readings, such as, for example, photodiode sensor data 410. A tracking filter 420 compares the predicted sensor readings 410 to actual measured sensor data 430 received from the AMM 110. The difference is used to generate an updated thermal model 440 which is output by the tracking filter 420 to replace the existing thermal model 150.

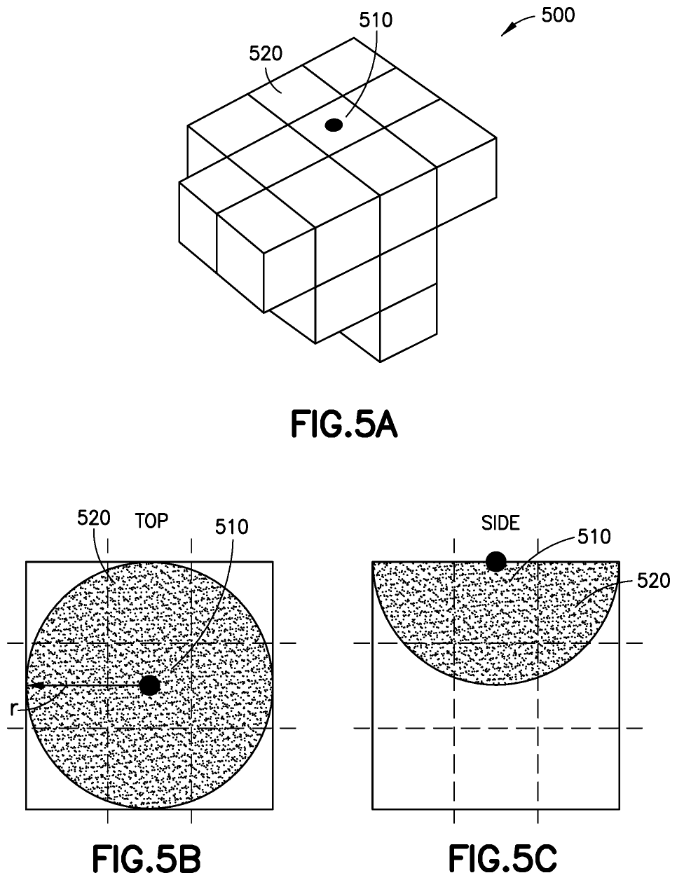

FIG. 5A depicts a portion of a part 500 which is voxelized to produce a nominal thermal model. For example, a part 500 may be divided into cubes of, for example approximately 0.3 to 1.0 mm in dimension. Other sizes are possible and may be selected based on the geometry of the part 500. As the laser scans each voxel during the build process, a portion of the heat generated in the voxel dissipates to neighboring voxels 520. As shown in FIG. 5B, for a particular voxel 510, the heat dissipation can be estimated by determining the number of adjacent voxels within a determined radius (r). If, for example, a voxel 510 (as viewed from the top) is surrounded on all sides with adjacent voxels 520, the voxel 510 can be expected to dissipate a relatively large portion of the heat resulting from the scan. On the other hand, as shown in FIG. 5C, if the voxel 510 (as viewed from the side), is positioned on top of the built part 500, then the radius of heat dissipation is only applicable to the neighboring voxels 520 at or below the top surface, which leaves an entire (i.e., upper) hemisphere which does not have neighboring voxels to provide heat dissipation.

In disclosed embodiments, a tracking loop is provided which starts with a nominal thermal model, i.e., a heat dissipation model for a part being built. In such a case, the input to the ILC includes a thermal model of the part and the scan file (e.g., CLI build file). Based on this, the ILC predicts what the sensor response is going to look like, e.g., what spots in the part are going to be hotter than allowable, colder than allowable, etc., based on thermal characteristics. For example, corners have less heat flow/conductivity will therefore become hotter than other portions of the part if the same amount of energy is applied. In the middle region of the part, on the other hand, there is a lot of heat conductivity (i.e., more paths for heat to dissipate), so if the same amount of energy is applied, the regions in question will be colder because heat can flow away more easily.

If a perfect thermal model were available, then an iterative learning loop would not be needed. In such a case, one would have the model, and a reference, e.g., a response surface/map based on sensor data, so an ideal build file could be generated to achieve a specific defined quality outcome. In practice, an approximate model is available which is sufficient for control purposes, but which results actual sensor data differing from predicted values. These differences (i.e., estimation error) can be fed back to update model through tracking filter. Therefore, for each build, the nominal thermal model is updated based on the estimation error. After a few iterations, the nominal thermal model with an updated parameter set will have very high fidelity which will help the ILC to converge faster.

As noted above, the determination of the nominal (i.e., initial) thermal model may include analysis of the part geometry, e.g., a part that has trapezoidal geometry in three-dimensions, by creating voxels at different resolutions and calculating for each voxel how much metal is connected beneath it. For example, in the case of a voxel in the middle of part, then all of the voxel volume will have solid metal beneath it, so the volume fraction (VF) would be 1. Near a corner, on the other hand, the volume fraction may be about 1/4. In the case of an arch-shaped geometric feature, a voxel at a middle point would have almost no metal, so volume fraction will be close to zero. In this way, the geometry is analyzed, and a volume fraction is assigned to each voxel and the model is stored, for example, in file format HDFS. A set of experiments may be performed setting laser power, speed, and focus on a volume fraction and using the measured intensity sensor data to create a regression that can predict sensor data based on input and volume fraction of the model. This is the nominal thermal model to predict sensor data. To the extent the thermal model does not match with measured intensity sensor data, then coefficients of the model (e.g., C0, C1, and C2, discussed herein) are adjusted based on the tracking filter algorithm so that it matches better.

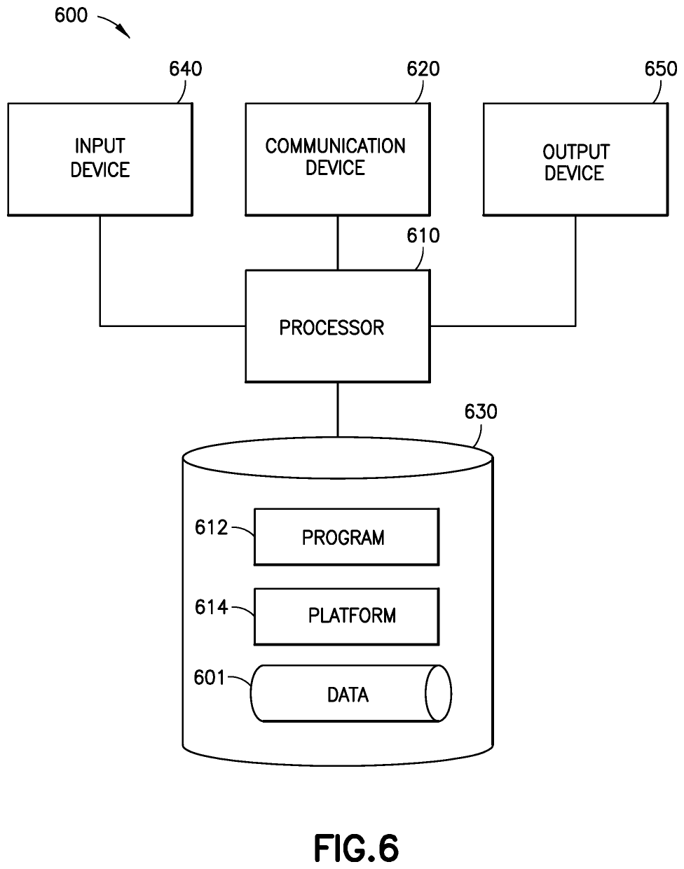

FIG. 6 is a block diagram of apparatus 600 according to some embodiments. Apparatus 600 may comprise a general-purpose or special-purpose computing apparatus and may execute program code to perform any of the functions described herein. Apparatus 600 may comprise an implementation of one or more elements of system 100. Apparatus 600 may include additional elements which are not shown, according to some embodiments.

Apparatus 600 includes processor 610 operatively coupled to communication device 620, data storage device/memory 630, one or more input devices (not shown), and one or more output devices 630. The network interface 620 may facilitate communication with external devices, such as an application server. Input device(s) may be implemented in the apparatus 600 or in a client device connected via the network interface 620. The input device(s) may comprise, for example, a keyboard, a keypad, a mouse or other pointing device, a microphone, knob or a switch, an infra-red (IR) port, a docking station, and/or a touch screen. Input device(s) may be used, for example, to manipulate graphical user interfaces and to input information into apparatus 600. Output device(s) 630 may comprise, for example, a display (e.g., a display screen) a speaker, and/or a printer.

Data storage device/memory 640 may comprise any device, including combinations of magnetic storage devices (e.g., magnetic tape, hard disk drives and flash memory), optical storage devices, Read Only Memory (ROM) devices, Random Access Memory (RAM) etc.

The storage device 640 stores a program and/or platform logic for controlling the processor 610. The processor 610 performs instructions of the programs and thereby operates in accordance with any of the embodiments described herein, including but not limited to the processes.

The programs may be stored in a compressed, uncompiled and/or encrypted format. The programs may furthermore include other program elements, such as an operating system, a database management system, and/or device drivers used by the processor 610 to interface with peripheral devices.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more computer-readable non-transitory media. Such media non-transitory media may include, for example, a fixed disk, a floppy disk, a CD-ROM, a DVD-ROM, a Flash drive, magnetic tape, and solid-state RAM or ROM storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A method for providing updated build parameters to an additive manufacturing machine, the method comprising:
receiving, via a communication interface of a device comprising a processor, sensor data from the additive manufacturing machine during manufacture of the part using a first set of build parameters;
receiving the first set of build parameters;
determining, using the processor of the device, an evaluation parameter based on the first set of build parameters and the received sensor data;
generating, using the processor of the device, thermal data based on a thermal model of the part derived from the first set of build parameters;
applying, using the processor of the device, a first algorithm to the received sensor data, the determined evaluation parameter, and the generated thermal data to produce a second set of build parameters, the first algorithm being trained to improve the evaluation parameter; and
outputting the second set of build parameters to the additive manufacturing machine to produce a second part.

2. The method of claim 1, wherein the evaluation parameter comprises a quality score determined by applying a second algorithm to the first set of build parameters and the received sensor data.

3. The method of claim 2, wherein the second algorithm is trained by receiving a reference derived from physical measurements performed on at least one reference part built using a reference set of build parameters.

4. The method of claim 1, wherein the generating of the thermal data comprises computing a first set of thermal data values based on a nominal thermal model and the first set of build parameters.

5. The method of claim 4, wherein the generating of the thermal data further comprises:
determining an updated thermal model based on a comparison of the first set of computed thermal data values to the received sensor data; and
computing a second set of thermal data values based on the updated thermal model.

6. The method of claim 4, wherein the nominal thermal model is derived by:
dividing a volume of the part into voxels;
determining a relative amount of surrounding material within a defined radius of a center of each of the voxels; and
computing thermal data values for each voxel based on the relative amount of surrounding material.

7. The method of claim 1, wherein the sensor data is received from at least one of a laser power sensor, an actuator sensor, a melt pool sensor, and an environmental sensor.

8. A system for providing updated build parameters to an additive manufacturing machine, the system comprising:
a device comprising a communication interface configured to receive sensor data from the additive manufacturing machine during manufacture of the part using a first set of build parameters, the device further comprising a processor configured to perform:
receiving the first set of build parameters;
determining an evaluation parameter based on the first set of build parameters, and the received sensor data;
generating thermal data based on a thermal model of the part derived from the first set of build parameters;
applying a first algorithm to the received sensor data, the determined evaluation parameter, and the generated thermal data to produce a second set of build parameters, the first algorithm being trained to improve the evaluation parameter; and
outputting the second set of build parameters to the additive manufacturing machine to produce a second part.

9. The system of claim 8, wherein the evaluation parameter comprises a quality score determined by applying a second algorithm to the first set of build parameters and the received sensor data.

10. The system of claim 9, wherein the second algorithm is trained by receiving a reference derived from physical measurements performed on at least one reference part built using a reference set of build parameters.

11. The system of claim 8, wherein the generating of the thermal data comprises computing a first set of thermal data values based on a nominal thermal model and the first set of build parameters.

12. The system of claim 11, wherein the generating of the thermal data further comprises:
determining an updated thermal model based on a comparison of the first set of computed thermal data values to the received sensor data; and
computing a second set of thermal data values based on the updated thermal model.

13. The system of claim 11, wherein the nominal thermal model is derived by:
dividing a volume of the part into voxels;
determining a relative amount of surrounding material within a defined radius of a center of each of the voxels; and
computing thermal data values for each voxel based on the relative amount of surrounding material.

14. A non-transitory computer-readable storage medium storing program instructions that when executed cause a processor to perform a method for providing updated build parameters to an additive manufacturing machine, the method comprising:
receiving, via a communication interface of a device comprising the processor, sensor data from the additive manufacturing machine during manufacture of the part using a first set of build parameters;
receiving the first set of build parameters;
determining, using the processor of the device, an evaluation parameter based on the first set of build parameters, and the received sensor data;
generating, using the processor of the device, thermal data based on a thermal model of the part derived from the first set of build parameters;
applying, using the processor of the device, a first algorithm to the received sensor data, the determined evaluation parameter, and the generated thermal data to produce a second set of build parameters, the first algorithm being trained to improve the evaluation parameter; and
outputting the second set of build parameters to the additive manufacturing machine to produce a second part.

15. The computer-readable storage medium of claim 14, wherein the evaluation parameter comprises a quality score determined by applying a second algorithm to the first set of build parameters and the received sensor data.

16. The computer-readable storage medium of claim 15, wherein the second algorithm is trained by receiving a reference derived from physical measurements performed on at least one reference part built using a reference set of build parameters.

17. The computer-readable storage medium of claim 14, wherein the generating of the thermal data comprises computing a first set of thermal data values based on a nominal thermal model and the first set of build parameters.

18. The computer-readable storage medium of claim 17, wherein the generating of the thermal data further comprises:
determining an updated thermal model based on a comparison of the first set of computed thermal data values to the received sensor data; and
computing a second set of thermal data values based on the updated thermal model.

19. The computer-readable storage medium of claim 17, wherein the nominal thermal model is derived by:
dividing a volume of the part into voxels;
determining a relative amount of surrounding material within a defined radius of a center of each of the voxels; and
computing thermal data values for each voxel based on the relative amount of surrounding material.

20. The computer-readable storage medium of claim 14, wherein the sensor data is received from at least one of a laser power sensor, an actuator sensor, a melt pool sensor, and an environmental sensor.
